(19) United States
(12) Patent Application Publication
(10) Pub. No.: US 2025/0245692 A1
(43) Pub. Date: Jul. 31, 2025

(54) METHOD, APPARATUS AND ELECTRONIC DEVICE FOR DISPLAYING SEARCH RESULTS

(71) Applicant: Hangzhou Alibaba International Internet Industry Co., Ltd., Hangzhou (CN)

(72) Inventor: Jinjin KE, Hangzhou (CN)

(21) Appl. No.: 19/022,524

(22) Filed: Jan. 15, 2025

(30) Foreign Application Priority Data
Jan. 25, 2024 (CN) 202410104070.5

(51) Int. Cl. G06Q 30/0242; G06Q 30/0601; G06V 10/74

(52) U.S. Cl. CPC G06Q 30/0243; G06Q 30/0629; G06V 10/761

(57) ABSTRACT

The embodiments of this application provide a method for displaying search results. The method includes: determining at least one first key image configured by a first user for a target object with an advertising requirement; upon receiving an information search request initiated by a second user based on a second key image, determining matching search results according to the second key image, and determining a degree of match between the second key image and the at least one first key image; based on the degree of match, determining whether the target object bound to the first key image qualifies to compete for a target display resource on the search result page, wherein the target display resources are provided to fulfill the advertising requirement.

### CROSS-REFERENCE TO RELATED APPLICATIONS

This application claims priority to Chinese Patent Application No. 202410104070.5, filed with the China National Intellectual Property Administration on Jan. 25, 2024, and entitled “Method, Apparatus and Electronic Device for Displaying Search Results,” which is incorporated herein by reference in its entirety.

### TECHNICAL FIELD

This application pertains to the field of information search technology, specifically to displaying search results method, apparatus and electronic device.

### BACKGROUND

In traditional search engine systems, users can initiate a search by entering keywords, and the system generates matching search results. For example, in a product information service system, users can search for products by entering keywords, among other methods. In such cases, this type of information search system can also serve as a channel for information promotion. Information publishers, such as merchants, can configure keywords based on titles, categories, or other attributes of the products or information they publish. By investing certain resources, they can compete for display or click opportunities with similar information published by other merchants. In this way, if a consumer user enters a specific keyword and initiates a search, and this keyword matches one configured by an information publisher, the related product information associated with that publisher will qualify for enhanced display or click opportunities. Consequently, this information may be displayed in certain designated resource slots on a search result page (e.g., the first slot or a specialized slot positioned alongside standard search results). This arrangement increases the chances of display or clicks, thereby facilitating the promotion and dissemination of the information.

With the development of search engine systems, an image-based search mode has emerged. In this mode, consumer users can initiate a search by inputting an image, among other methods. The search engine system can then compare the image of a product or related items with the user-provided image through similarity analysis to determine if it meets the user's search needs. Based on this comparison, the system generates search results and returns them to the user.

However, in this image-based search mode, the method of promoting product information using keywords configured by merchants or other information publishers becomes unavailable. Consequently, a technical challenge arises: how to enable merchants and other information publishers to increase the exposure of their product information through certain configuration operations within the image-based search mode. This challenge requires a solution from professionals in the field.

### SUMMARY

This application provides a displaying search results method, apparatus and electronic device. In scenarios where a search is initiated based on a key image, this approach enables the determination of whether certain display objects qualify for increased display or click opportunities through key image comparison.

This application provides the following solution:
a method for displaying search results, comprising:
determining at least one first key image configured by a first user for a target object with an advertising requirement;
upon receiving an information search request initiated by a second user based on a second key image, determining matching search results according to the second key image, and performing a similarity comparison between the second key image and the at least one first key image to determine a degree of match between the second key image and at least one first key image;
based on the degree of match, determining whether the target object bound to the first key image qualifies to compete for a target display resource on a search result page; the target display resource is provided to meet the advertising requirement.

The similarity comparison between the second key image and the at least one first key image comprises:
performing a similarity comparison between the main subject image in the second key image and the main subject image in the at least one first key image.

The main subject image is an image related to a product object.

The method further comprises:
determining whether a first product object corresponding to the main subject image in the at least one first key image and a second product object corresponding to the main subject image in the second key image belong to the same product category;
if they belong to the same product category, triggering the step of performing a similarity comparison between the main subject image in the second key image and the main subject image in the at least one first key image.

The method further comprises:
determining the key attributes of the product based on the product category, so that during the main subject image comparison, the comparison is performed based on the key attributes, while non-key attributes are ignored or assigned a lower weight.

The method further comprises:
if the degree of match between the second key image and at least one first key image meets a preset condition, performing a similarity comparison between the second key image and a representative image associated with the target object bound to the first key image. If a comparison result meets the preset condition, determining that the target object bound to the first key image qualifies to compete for the target display resource on the search result page.

The target object includes a product object, and the representative image associated with the target object includes the main image of the product object.

If a plurality of first key images and their corresponding target objects successfully match the second key image, sorting the target objects corresponding to the plurality of first key images based on bid information configured by the first user for the first key images or premium information configured for the target display resource, to determine the target object that will obtain the target display resources on the search result page.

An advertising placement method, comprises:
providing an option for configuring a key image within an interface used for configuring an advertisement for a target object;
receiving at least one first key image submitted by a first user through the provided configuration option;
establishing an binding relationship between the target object and the at least one first key image, so that upon receiving an information search request initiated by a second user based on a second key image, a similarity comparison may be performed between the second key image and the at least one first key image to determine a degree of match between the second key image and the at least one first key image, and based on the degree of match, determining whether the target object bound to the first key image qualifies to compete for a target display resource on the search result page, wherein the target display resource is provided to fulfill an advertising requirement.

The method further comprises:
providing an option for configuring bids individually for each of at least one keywords, allowing bid configurations to be applied to each keyword individually through this option.

A search result display apparatus, comprises:
a key image configuration information determination unit, configured to determine at least one first key image configured by a first user for a target object with an advertising requirement;
a key image matching unit configured to determine matching search results based on a second key image upon receiving an information search request initiated by a second user based on a second key image, and to perform a similarity comparison between the second key image and the at least one first key image to determine the degree of match between the second key image and the at least one first key image;
a display qualification determination unit configured to determine, based on the degree of match, whether the target object bound to the first key image qualifies to compete for a target display resource on the search result page, wherein the target display resource is provided to fulfill the advertising requirement.

A computer-readable storage medium storing a computer program, wherein, when executed by a processor, the program performs the steps of the method described in any of the preceding claims.

An electronic device, comprising:
one or more processors; and
a memory associated with the one or more processors, wherein the memory is configured to store program instructions that, when read and executed by the one or more processors, perform the steps of the method described in any of the preceding claims.

A computer program product comprising a computer program or a computer-executable instruction, wherein, when executed by a processor in an electronic device, the computer program or computer-executable instructions perform the steps of the method described in any of the preceding claims.

According to specific embodiments provided in this application, the following technical effects are disclosed:

In the embodiments of this application, for information publishers such as merchants who need to advertise a target object, a first key image can be configured for the target object. This allows, when a consumer or similar user initiates a search request by inputting a second key image, both natural search results based on the second key image to be obtained, as well as a similarity comparison between the first and second key images. By assessing the degree of match between the first key image configured by the merchant and the second key image in the current search request, if the match meets specified conditions, the target object bound to the first key image can be qualified to compete for target display resources on the search result page. This approach enables the determination, in image-based search scenarios, of whether certain display objects can compete for target display resources on the search result page based on key image comparison. Compared with keyword-based matching to key images, this method yields more accurate comparison results and reduces the likelihood of low relevance between displayed objects in specific resource slots and the actual search intent.

Of course, implementing any product of this application does not necessarily require achieving all of the advantages described above simultaneously.

### BRIEF DESCRIPTION OF THE DRAWINGS

To clarify the technical solutions in the embodiments of this application or the prior art, a brief introduction to the figures required in the embodiments is provided below. It is evident that the figures described below represent only some embodiments of this application. Those skilled in the art could derive additional figures based on these without requiring inventive effort.

FIG. 1 is a schematic diagram of the system architecture provided in an embodiment of this application;

FIG. 2 is a flowchart of the first method provided in an embodiment of this application;

FIG. 3 is a flowchart of the second method provided in an embodiment of this application;

FIG. 4 is a schematic diagram of the first apparatus provided in an embodiment of this application;

FIG. 5 is a schematic diagram of the second apparatus provided in an embodiment of this application;

FIG. 6 is a schematic diagram of the electronic device provided in an embodiment of this application.

### DETAIL DESCRIPTION OF THE EMBODIMENTS

The technical solutions in the embodiments of this application will be clearly and thoroughly described below in conjunction with the accompanying drawings. It is evident that the described embodiments are merely part of the embodiments of this application and not exhaustive. All other embodiments obtained by those skilled in the art based on the embodiments in this application fall within the scope of protection of this application.

Firstly, it should be noted that in scenarios where searches are conducted based on key images, a feasible implementation to enable information publishers to advertise their target objects is as follows (using an e-commerce scenario as an example). Merchant users can still configure certain keywords based on the characteristics of the products they publish. In e-commerce context, such keywords typically relate to product categories, such as “bicycle” or more specific subcategories like “mountain bike,” “road bike,” or “folding bike.” When necessary, merchants may place bids on specific configured keywords to increase the likelihood of their products being displayed in advertising resource slots. When a consumer user initiates a search by inputting a key image, a challenge arises because the merchant's configuration is based on “keywords,” while the consumer's input is a “key image.” To address this, matching between keywords and the key image becomes necessary. A feasible approach in this case is to first perform primary recognition on the key image provided by the user to identify the main subject and, if possible, the product category it corresponds to (this can be achieved using existing computer vision techniques). Subsequently, the identified product category and related information can be compared against the merchant-configured keywords to assess the degree of match. Based on this match, it can then be determined whether to promote the merchant's specified product on the search result page.

However, with the approach described above, the need to match “keywords” with “key images” demands a high level of accuracy in key image recognition, which may result in less accurate matching outcomes during implementation. For instance, the number of keywords is typically limited; for “bicycle”-related keywords, there might be fewer than ten, including categories like mountain bikes, road bikes, folding bikes, as well as children's bikes, vintage bikes, and commuter bikes. In contrast, the “key image” input by the user can vary greatly, and it may not always be possible to accurately identify the exact type of bicycle from the image. This limitation makes it challenging to achieve precise matching with the keywords configured by merchants.

Additionally, when promoting a merchant's product based on configured keywords, it is essential to consider the relevance between the promoted product and the current search intent of the consumer. In image-based searches, consumers typically have a relatively specific goal, often aiming to find the exact or similar item shown in the key image—such as a particular model of bicycle. In cases where precise matching with merchant-configured keywords cannot be achieved, forcing the promotion of a product based on those keywords, especially in prime positions like the top slot on the search result page, could negatively impact user experience. For example, a consumer might input a key image of a folding bicycle, specifically intending to find the same or similar model with matching features such as appearance, brand, and model. Merchant-configured keywords, however, are often limited to product categories and rarely include detailed descriptions of the product's appearance. In such cases, if the product category recognized from the key image matches the merchant's configured keyword, promoting the corresponding product on the search result page could result in a mismatch with the consumer's actual search needs. For instance, while the consumer's key image might include various distinctive features of a particular bicycle, the promoted product might only meet the basic “bicycle” category requirement, differing significantly from the product in the key image. This discrepancy can clearly impact user experience by failing to present relevant options.

To address the issues outlined above, this application provides an implementation for merchant users to advertise their products by configuring “key images.” In other words, if a merchant wishes to advertise a particular product, they can pre-configure a key image for that product. Thus, when a consumer initiates a search by inputting a key image, the system can first match the user-provided key image with the main image or similar visuals of specific products and determine search results that meet the search criteria based on the degree of match (which may include a plurality of display objects, such as different products). Additionally, for these search results, a similarity comparison can be performed between the consumer's input key image and the merchant-configured key image. If the match between the key images meets predefined conditions, the corresponding bound product or target object can qualify to compete for target display resources on the search result page. If it succeeds in this competitive process, the target object can then be displayed in a prominent resource slot on the search result page.

In this way, information publishers, such as merchants, can advertise by configuring a “key image” for their target objects and setting bids for these key images. When a consumer user inputs a key image, a similarity comparison can be performed between the user's key image and the merchant-configured key images to determine whether the target object associated with the merchant's key image qualifies to compete for display resources on the search result page. This method of comparing key images with each other provides higher accuracy compared to matching a key image with merchant-configured keywords. Additionally, it ensures that the target objects gaining advertising resources are more closely aligned with the user's actual search intent, thus supporting effective advertising while minimizing the impact on user experience.

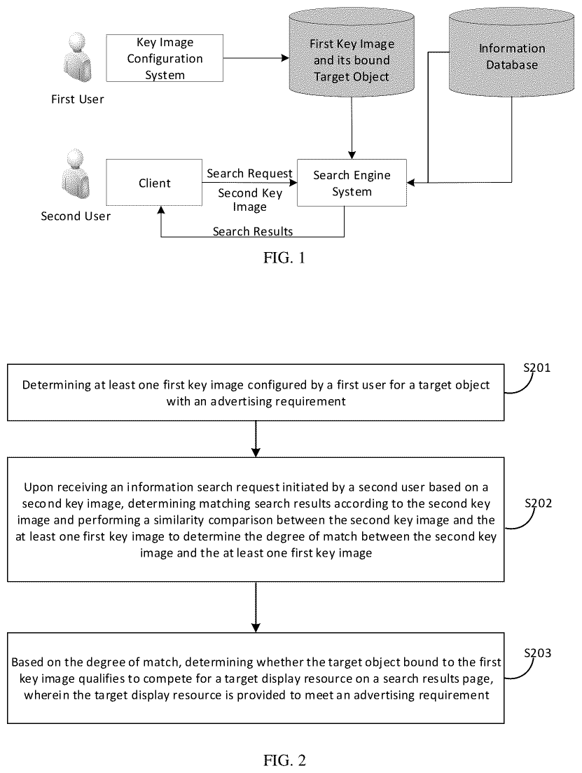

From a system architecture perspective, as illustrated in FIG. 1, the embodiments of this application can provide a system for merchants and other users to configure key images, enabling them to designate target objects for advertising and assign key images accordingly. For example, in an e-commerce scenario, these target objects are typically products. During the key image configuration process, merchants can also receive key image recommendations from the system. Once the key image configuration is completed, users can set bid configurations based on these key images to compete with other target objects that have the same or similar key images configured. Additionally, there may be a plurality of advertising resource slots on the search result page, including special slots like the “top slot,” which offer higher advertising effectiveness. Premium bid configurations can be applied specifically for these high-value slots, allowing users to place additional bids for preferred slots to increase the likelihood that their target objects appear in such advantageous positions. After completing configurations for key images, bids, and premium adjustments, the settings can be saved. When the search engine system later processes consumer searches, it can compare the consumer's submitted key image with the key images configured by merchants to determine whether the target object associated with a particular key image qualifies to compete for display resources on the search result page. Based on the results of this comparison, target objects with successful matches can then be considered eligible to compete for specific resource slots on the search result page.

The following provides a detailed description of the specific implementation schemes offered in the embodiments of this application.

### Embodiment 1

Firstly, embodiment 1 provides a method for displaying search results, as shown in FIG. 2. This method may include:

S201: determining at least one first key image configured by a first user for a target object with an advertising requirement.

The first user may be an information publisher such as a merchant, and the first key image can be an image configured by the first user based on specific needs. For example, in practical implementation, the first user (such as a merchant) could obtain specific images by photographing the product and then submit these images through the system's key image configuration interface. The submitted image then becomes the first key image. Furthermore, the first key image can be bounded to a specific target object for advertising, such as a particular product ID. A single first user may configure a plurality of first key images, with each key image either bounded to the same target object or to different ones. In certain systems, it may also be possible to allocate resources for the first key image, such as setting bids. A plurality of first key images associated with the same target object can have separate bids. Additionally, premium configurations can be set for special resource slots on the search result page. For instance, for the “top slot” on the search result page (the first resource position), a 40% bid increase can be applied, where this 40% represents the premium percentage.

S202: upon receiving an information search request initiated by a second user based on a second key image, determining matching search results according to the second key image and performing a similarity comparison between the second key image and the at least one first key image to determine the degree of match between the second key image and the at least one first key image.

The second user can specifically be a consumer or other user initiating a search request. Once the first user has configured the first key image, if the second user inputs a second key image and initiates an information search request, matching search results can first be determined based on the second key image. The search results obtained in this step can be referred to as natural search results, meaning the results generated without the intervention of key images configured by the first user. For example, in a product search scenario, after the second user inputs the second key image, this image can be compared for similarity against the main images of a plurality of products in the product database, determining the degree of match between each product and the second key image. Products meeting the matching criteria can then be selected as the matching search results.

On the other hand, in addition to obtaining natural search results, a similarity comparison can be performed between the second key image and at least one first key image configured by the first user to determine the degree of match between the second key image and the first key image(s). When performing the similarity comparison between the first and second key images, a direct pixel-by-pixel comparison of the two images can be used. Alternatively, considering that in scenarios such as product searches, the primary focus for users in both the first and second key images is typically the main subject of the image. The “subject” refers to the main object of focus in the image, which constitutes the primary component of the composition, acts as the visual center drawing the viewer's attention, and represents the main content of the image. For example, in an e-commerce scenario, the primary part of a key image usually corresponds to the product itself. Therefore, to avoid interference from background elements, the comparison process may begin with subject identification in both key images, followed by a similarity comparison focused on the main subject areas.

In e-commerce (also known as product information service) scenarios, before performing a similarity comparison on the main subject images, a category recognition process may first be applied to the main subject images. This involves determining whether the primary product object in the main subject of at least one first key image and the primary product object in the main subject of the second key image belong to the same product category. If they belong to the same category, the similarity comparison between the main subject images in the second key image and the first key image(s) can then be triggered. Otherwise, if the product objects in the two key images are not of the same type, subsequent similarity comparison steps can be skipped, thereby conserving computational resources. Category recognition can be implemented using existing computer vision algorithms available in the current technology.

Additionally, when it is possible to identify the product category of the item in the key image, key attributes of the product can be determined based on this category information. This allows the comparison of main subject images to focus on these key attributes while ignoring or assigning lower weights to non-key attributes. For instance, regarding color attributes, color may not be a critical factor for some products. In such cases, users may be more concerned with aspects like style and shape rather than color when searching for products. Thus, color would be considered a non-key attribute for these products and could be disregarded during comparison. For example, in the case of bicycles mentioned previously, if the second key image submitted by the user depicts a red bicycle, while a merchant's first key image shows a green bicycle, a direct pixel-level comparison might yield a low similarity score due to the color difference. However, since color is generally not a significant attribute for bicycles, the comparison could overlook the color attribute and focus on characteristics such as model and design. This way, if the first and second key images have a high similarity in aspects like bicycle model and design, but differ in color, the images would still be considered highly similar.

However, for products in categories such as “lipstick,” color is a highly sensitive attribute. If a second user inputs a key image of a particular lipstick, possibly showing the actual shade of the product, they are likely seeking a lipstick of the same brand and color. In this case, when performing a similarity comparison with the first key image configured by a merchant, color can be treated as a key attribute. That is, if there is a noticeable difference in color between the two key images, even if they are very similar in brand, shape, or style, the overall similarity score may be low.

S203: based on the degree of match, determining whether the target object bound to the first key image qualifies to compete for a target display resource on a search result page, wherein the target display resource is provided to meet an advertising requirement.

After determining the degree of match between the second key image input by the second user and the first key image configured by the first user, this match level is used to assess whether the target object bound to the first key image is eligible to compete for target display resources on the search result page. In practice, to further verify alignment with the user's search intent for successfully matched display objects, an additional similarity comparison can be performed between the second key image and the main image of the display object. For instance, in an e-commerce scenario, once a successful match is established between the second key image and the first key image, a comparison can then be made between the second key image and the main image of the product associated with the first key image. If the similarity between these images also meets predefined conditions, the product can be confirmed as a promotional candidate in the current search process, meaning it qualifies to compete for target display resources on the search result page.

Target display resources on the search result page can take various forms. For example, specific positions on the search result page, such as the 1st, 5th, or 10th slots, can be designated as target display resources for showcasing promoted objects. Alternatively, the top N slots on the search result page can be allocated entirely as target display positions for promoted objects. Another option is to reserve a sidebar or similar area on the search result page to centrally display promotional items.

Additionally, as previously mentioned, when configuring a first key image, the first user may also set bid information for the key image, allowing the user to pay the platform according to the configured bid if the key image is used to promote the associated target object. Different first users may configure similar first key images with varying bid amounts. In cases where a plurality of first key images match the second key image, the target objects associated with these first key images can be ranked based on their respective bid amounts. During the display process, metrics such as impressions and clicks on specific target objects can be tracked, enabling the first user to settle payments with the platform based on their configured bid information. Additionally, if premium bid configurations are set for special resource slots, these configurations can be used to determine which target object qualifies for display in these high-value slots.

In summary, through the embodiments of this application, information publishers, such as merchants, who wish to advertise a target object can configure a first key image for that object. When a consumer or similar user initiates a search request by inputting a second key image, natural search results based on the second key image can be obtained. Additionally, a similarity comparison between the first and second key images can determine the match degree between the merchant-configured first key image and the second key image in the current search request. If the match meets the required conditions, the target object bound to the first key image can qualify to compete for target display resources on the search result page. This approach enables a determination, in scenarios where searches are initiated based on key images, of whether certain display objects qualify to compete for target display resources through key image comparison. Compared to matching between keywords and key images, this method provides more accurate comparison results and helps reduce instances of low relevance between displayed objects in premium slots and the user's specific search intent.

### Embodiment 2

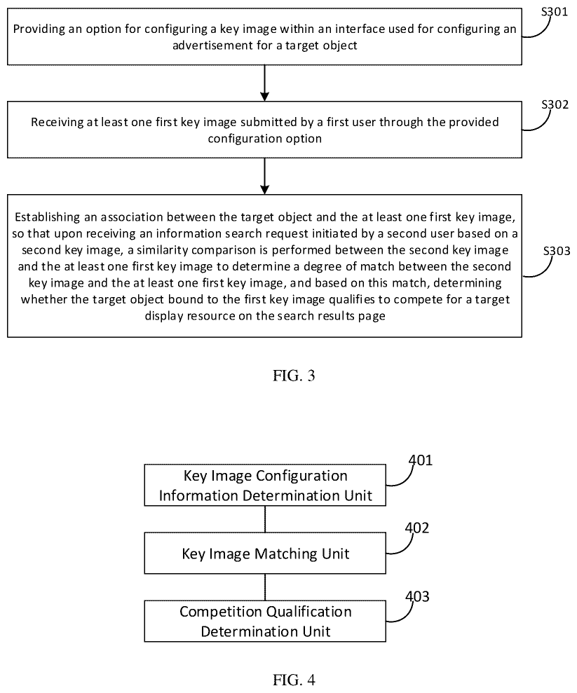

Embodiment 2 provides an advertising placement method from the perspective of a first user (e.g., a merchant), outlining the process for configuring advertisements. In this embodiment, if a merchant intends to advertise a target object within a search context, they can configure one or more key images for that object. This enables a key image-based matching process in scenarios where a consumer initiates a search using a key image, allowing for the determination of whether the specified target object qualifies to compete for target display resources on the search result page. Referring specifically to FIG. 3, this method may include:

S301: providing an option for configuring a key image within an interface used for configuring an advertisement for a target object.

S302: receiving at least one first key image submitted by a first user through the provided configuration option.

S303: establishing a binding relationship between the target object and the at least one first key image. Upon receiving an information search request initiated by a second user based on a second key image, a similarity comparison is performed between the second key image and the at least one first key image to determine a degree of match between them. Based on this match, determining whether the target object bound to the first key image qualifies to compete for a target display resource on the search result page.

In specific implementations, an option can also be provided for configuring bids individually for each of the at least one keyword, allowing bid configurations to be set for each keyword through this option.

It should be noted that this embodiment may involve the use of user data. In practical applications, user-specific personal data may be used within the scope permitted by applicable laws and regulations of the respective country (for example, with the user's explicit consent, or after clear notification to the user), and in compliance with relevant legal requirements.

Corresponding to method of embodiment 1, this application also provides a search result display apparatus, as shown in FIG. 4. The apparatus may include:

a key image configuration information determination unit 401, configured to determine at least one first key image set by a first user for a target object with advertising requirements;
a key image matching unit 402, configured to determine matching search results based on the second key image upon receiving an information search request initiated by a second user, and to perform a similarity comparison between the second key image and the at least one first key image to determine the degree of match between the second key image and at least one first key image;
a competition qualification determination unit 403, configured to determine, based on the degree of match, whether the target object bound to the first key image qualifies to compete for target display resources on the search result page, wherein the target display resources are provided to fulfill advertising requirements.

The key image matching unit may be specifically configured to:
performing a similarity comparison between the main subject image in the second key image and the main subject image in the at least one first key image.

Specifically, the main subject image is an image related to a product object.

The apparatus may further include:
a category determination unit, configured to determine whether the first product object corresponding to the main subject image in the at least one first key image and the second product object corresponding to the main subject image in the second key image belong to the same product category;
a trigger unit, configured to initiate the step of performing a similarity comparison between the main subject image in the second key image and the main subject image in the at least one first key image, if they belong to the same product category.

Additionally, the apparatus may further include:
a key attribute determination unit, configured to determine the key attributes of the product based on the product category, allowing the comparison of main subject images to focus on these key attributes while ignoring or assigning a lower weight to non-key attributes.

Furthermore, the apparatus may also include:
a secondary comparison unit, configured to, if the degree of match between the second key image and at least one first key image meets preset conditions, perform a similarity comparison between the second key image and the representative image associated with the target object bound to the first key image. If the comparison result meets the preset conditions, it determines that the target object bound to the first key image qualifies to compete for target display resources on the search result page.

The target object includes a product object, and the representative image associated with the target object includes the main image of the product object.

In specific implementations, the apparatus may further include:
a sorting unit, configured to, if a plurality of first key images and their corresponding target objects successfully match the second key image, sort the target objects corresponding to the plurality of first key images based on bid information configured by the first user for the first key images or premium information configured for the target display resources, to determine the target object that will secure the target display resources on the search result page.

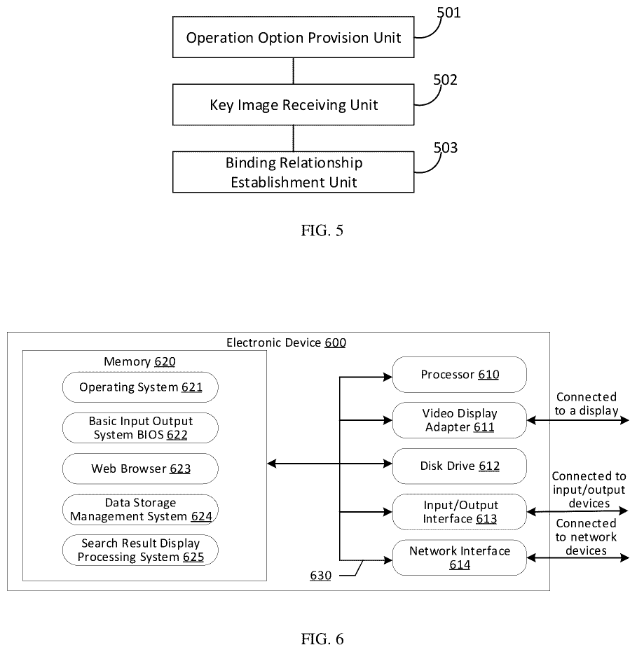

Corresponding to embodiment 2, this application also provides an advertising placement apparatus, as shown in FIG. 5. The apparatus may include:
an operation option provision unit 501, configured to provide an option for configuring key images within the interface used for advertising configuration of a target object;
a key image receiving unit 502, configured to receive at least one first key image submitted by the first user through the operation option;
a binding relationship establishment unit 503, configured to establish an binding relationship between the target object and the at least one first key image. Upon receiving an information search request initiated by a second user based on a second key image, this unit performs a similarity comparison between the second key image and the at least one first key image to determine the degree of match. Based on this match, it then assesses whether the target object bound to the first key image qualifies to compete for target display resources on the search result page.

Additionally, the apparatus may further include:
a bid configuration unit, configured to provide an option for setting bid configurations individually for each of the at least one keyword, allowing bid configurations to be applied to each keyword through this option.

Additionally, this application provides a computer-readable storage medium storing a computer program, which, when executed by a processor, implements the steps of the method described in the preceding method embodiments.

This application also provides an electronic device, comprising:
one or more processors; and
a memory associated with the one or more processors, where the memory is configured to store program instructions that, when read and executed by the one or more processors, perform the steps of the method described in the preceding method embodiments.

A computer program product comprising a computer program or computer-executable instructions, which, when executed by a processor in an electronic device, perform the steps of the method described in the preceding method embodiments.

FIG. 6 exemplarily illustrates the architecture of an electronic device 600, which may specifically include a processor 610, a video display adapter 611, a disk drive 612, an input/output interface 613, a network interface 614, and a memory 620. The processor 610, video display adapter 611, disk drive 612, input/output interface 613, network interface 614, and memory 620 can be communicatively connected via a communication bus 630.

The processor 610 may be implemented using a general-purpose CPU (Central Processing Unit), microprocessor, Application Specific Integrated Circuit (ASIC), or one or more integrated circuits, and is configured to execute relevant programs to implement the technical solutions provided in this application.

The memory 620 may be implemented in the form of ROM (Read Only Memory), RAM (Random Access Memory), static storage devices, dynamic storage devices, or other types. It can store the operating system 621, which controls the operation of the electronic device 600, and the Basic Input Output System (BIOS) 622 for managing low-level operations of the electronic device 600. Additionally, it may store a web browser 623, a data storage management system 624, and a search result display processing system 625, among other applications. The search result display processing system 625 can be the application that implements the steps described in the embodiments of this application. In summary, when the technical solutions provided by this application are implemented through software or firmware, the relevant program code is stored in memory 620 and executed by the processor 610.

The input/output interface 613 is used to connect input/output modules to facilitate information input and output. The input/output module may be configured as an internal component of the device (not shown in the figure) or as an external attachment to provide corresponding functionality. Input devices may include a keyboard, mouse, touchscreen, microphone, and various sensors, while output devices may include a display, speaker, vibrator, and indicator lights.

The network interface 614 is used to connect a communication module (not shown in the figure) to enable communication and interaction between this device and other devices. The communication module can establish connections via wired methods (such as USB or Ethernet) or wireless methods (such as mobile networks, WiFi, or Bluetooth).

The bus 630 provides a pathway for transmitting information between various components of the device, such as the processor 610, video display adapter 611, disk drive 612, input/output interface 613, network interface 614, and memory 620.

It should be noted that, although the device shown above includes only the processor 610, video display adapter 611, disk drive 612, input/output interface 613, network interface 614, memory 620, and bus 630, additional components necessary for normal operation may also be included in actual implementations. Moreover, those skilled in the art will understand that the device may contain only the components essential to implementing the solutions provided by this application, without requiring all components shown in the figure.

From the description of the above embodiments, it can be understood that those skilled in the art will recognize that this application can be implemented by means of software combined with a necessary general hardware platform. Based on this understanding, the technical solutions provided by this application, particularly the parts that contribute to the existing technology, can be embodied in the form of a software product. This computer software product can be stored on a storage medium, such as ROM/RAM, a magnetic disk, an optical disk, etc., and includes instructions that enable a computer device (such as a personal computer, server, or network device) to execute the methods described in each embodiment or certain parts of the embodiments of this application.

The various embodiments in this specification are described in a progressive manner, with similar or identical parts referenced across embodiments, focusing on the differences between each embodiment. Specifically, for system embodiments, as they are fundamentally similar to method embodiments, they are described more briefly, with relevant details cross-referenced in the method embodiments. The described systems and system embodiments arc illustrative only; units described as separate components may or may not be physically separated, and components displayed as units may or may not be physical units—they may be located in one place or distributed across a plurality of network units. Parts or all of the modules can be selected as needed to achieve the purposes of this embodiment. Those skilled in the art can readily understand and implement these concepts without inventive effort.

The search result display method, apparatus, and electronic device provided by this application have been described in detail above. Specific examples have been used to explain the principles and embodiments of this application. The descriptions of the above embodiments are intended to assist in understanding the methods and core concepts of this application. For those skilled in the art, variations in specific implementations and application scope may be made based on the concepts of this application. In conclusion, the content of this specification should not be construed as limiting the application.

What is claimed is:

1. A method for displaying search results, comprising:
determining at least one first key image from a first user for a target object with an advertising requirement;
upon receiving an information search request initiated by a second user based on a second key image, determining matching search results according to the second key image, and performing a similarity comparison between the second key image and the at least one first key image to determine a degree of match between the second key image and the at least one first key image;
based on the degree of match, determining whether the target object bound to the at least one first key image qualifies to compete for a target display resource on a search result page displaying the matching search results, wherein the target display resource is provided to meet the advertising requirement.

2. The method according to claim 1, wherein:
the similarity comparison between the second key image and the at least one first key image comprises:
performing a similarity comparison between a main subject image in the second key image and a main subject image in the at least one first key image.

3. The method according to claim 1, further comprising:
determining whether a first product object corresponding to a main subject image in the at least one first key image and a second product object corresponding to a main subject image in the second key image belong to the same product category;
if they belong to the same product category, the similarity comparison is between the main subject image in the second key image and the main subject image in the at least one first key image.

4. The method according to claim 3, further comprising:
determining key attributes of the product object based on the product category, such that during the main subject image comparison, the comparison is performed based on the key attributes while non-key attributes are ignored or assigned with a lower weight.

5. The method according to claim 1, wherein, based on the degree of match, determining whether the target object bound to the at least one first key image qualifies to compete for a target display resource on a search result page displaying the matching search results, comprises:
if the degree of match between the second key image and at least one first key image meets a preset condition, performing a similarity comparison between the second key image and a representative image associated with the target object bound to the at least one first key image; and
if a comparison result meets the preset condition, determining that the target object bound to the at least one first key image qualifies to compete for the target display resource on the search result page.

6. The method according to claim 5, wherein:
the target object includes a product object, and the representative image associated with the target object includes the main image of the product object.

7. The method according to claim 1, wherein:
if a plurality of first key images and their corresponding target objects match the second key image, sorting the target objects corresponding to the plurality of first key images based on bid information from the first user for the first key images or premium information for the target display resource, to determine the target object that will obtain the target display resource on the search result page.

8. A non-transitory computer-readable storage medium configured with instructions executable by one or more processors to cause the one or more processors to perform the method of claim 1.

9. An electronic device comprising:
one or more processors; and
one or more computer-readable memories coupled to the one or more processors and having instructions stored thereon that are executable by the one or more processors to perform the method of claim 1.

10. An advertising placement method, comprising:
providing an option for configuring a key image within an interface used for configuring an advertisement for a target object;
receiving at least one first key image submitted by a first user through the provided configuration option;
establishing a binding relationship between the target object and the at least one first key image, so that upon receiving an information search request initiated by a second user based on a second key image, a similarity comparison is performed between the second key image and the at least one first key image to determine a degree of match between the second key image and the at least one first key image, and based on the degree of match, determining whether the target object bound to the at least one first key image qualifies to compete for a target display resource on the search result page, wherein the target display resource is provided to fulfill an advertising requirement.

11. The method according to claim 10, further comprising:
providing an option for configuring bids individually for each of at least one keywords, and allowing bid configurations to be applied to each keyword through the option.

12. A non-transitory computer-readable storage medium configured with instructions executable by one or more processors to cause the one or more processors to perform the method of claim 10.

13. An electronic device comprising:
one or more processors; and
one or more computer-readable memories coupled to the one or more processors and having instructions stored thereon that are executable by the one or more processors to perform the method of claim 10.

14. A search result display apparatus, comprising:
a key image configuration information determination unit, configured to determine at least one first key image configured by a first user for a target object with an advertising requirement;
a key image matching unit, configured to determine matching search results based on a second key image upon receiving an information search request initiated by a second user based on a second key image, and to perform a similarity comparison between the second key image and the at least one first key image to determine a degree of match between the second key image and the at least one first key image;
a display qualification determination unit, configured to determine, based on the degree of match, whether the target object bound to the at least one first key image qualifies to compete for a target display resource on the search result page, wherein the target display resource is provided to fulfill the advertising requirement.

15. A non-transitory computer-readable storage medium configured with instructions executable by one or more processors to cause the one or more processors to perform the method of claim 14.

16. An electronic device comprising:
one or more processors; and
one or more computer-readable memories coupled to the one or more processors and having instructions stored thereon that are executable by the one or more processors to perform the method of claim 14.
